(19) United States
(12) Patent Application Publication
(10) Pub. No.: US 2006/0044463 A1
(43) Pub. Date: Mar. 2, 2006

(54) Method and thin image sensor with strain deformation

(76) Inventors: Micheal Talley, Boise, ID (US); Dana Jacobsen, Boise, ID (US); Terry Fritz, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/929,965

(22) Filed: Aug. 30, 2004

(51) Int. Cl. H04N 5/225

(52) U.S. Cl. 348/373

(57) ABSTRACT

Apparatus comprising a digital camera (or image capture device) and thin, deformable image sensor that is flexed to correct for sensor deformities and/or lens aberrations. The image sensor has attachments (piezoelectric devices) on its rear surface. The deformable attachments are electrically coupled to processing circuitry comprising firmware that deforms the sensor by digitally controlling the respective deformable attachments to vary the flatness of the sensor. This allows for correction of field flatness and some other lens aberrations. The sensor may be tilted, or deformed into concave or convex shapes, for example, to correct for flatness irregularities.

### TECHNICAL FIELD

The present invention relates to image sensors for use in digital cameras.

### BACKGROUND

In general, aberrations that are present in images taken by digital cameras are normally not compensated for in low end digital cameras. Alternatively, such aberrations may be post-processed after recording to remove them, which is done in some more-expensive digital cameras.

Canon and Nikon digital cameras move lens elements to adjust for camera shaking. For example, this is done in Canon's Image Stabilization series of cameras and Nikon's VR series of cameras. However, manufacturing tolerances, for example, still produce some aberrations.

A Minolta DiMage A1 camera has an image stabilization mechanism that moves a charge coupled device (CCD) sensor. This mechanism moves the entire sensor along x and y axes and does not use any intra-pixel movement. In addition, U.S. patent application No. 2002/0028071 (Claus Molgaard) describes how accelerometers can be used to discover camera motion. That application discusses how this can be either recorded or trigger an alarm, and in paragraph 0021, reference is made to compensation that may be performed by image processing or physically moving the sensor.

Applicants are not aware of any embodiment of a digital camera having a sensor that is flexed to adjust for aberrations.

### SUMMARY OF THE INVENTION

The present invention comprises systems embodied in a digital camera, or image capture device, that provide for a thin, flexible image sensor that is flexed to correct for sensor aberrations and lens deformities. In implementing the present invention, a thin deformable or flexible image sensor is used, and small deformations (strain deformation) of the sensor are made by an array of (piezoelectric) attachments on the back side of the sensor. These attachments are pushed and pulled using digital control such that small variations in the flatness of the sensor can be effected. This allows for correction of field flatness and some other lens aberrations. A variation of the present invention allows adjustment in gross levels, where the resulting sensor need not be approximately flat, and may be tilted, or deformed into concave or convex shapes, for example, to correct for such an irregularity.

The present invention implements a technique that is similar to one used in large telescopes to implement small mirror deformations. The deformation ability there is used not only to correct for fixed aberrations but also dynamically for atmospheric, temperature, and other changes. The difference with regard to the present invention is that image and video capture devices, such as cameras, do not use mirrors such as are used in catadioptric telescopes, but instead lenses and digital sensors.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are rear and front views, respectively, of an exemplary digital camera employing a flexible image sensor in accordance with the principles of the present invention; and

FIG. 2 illustrates details of an exemplary flexible image sensor in accordance with the present invention.

### DETAILED DESCRIPTION

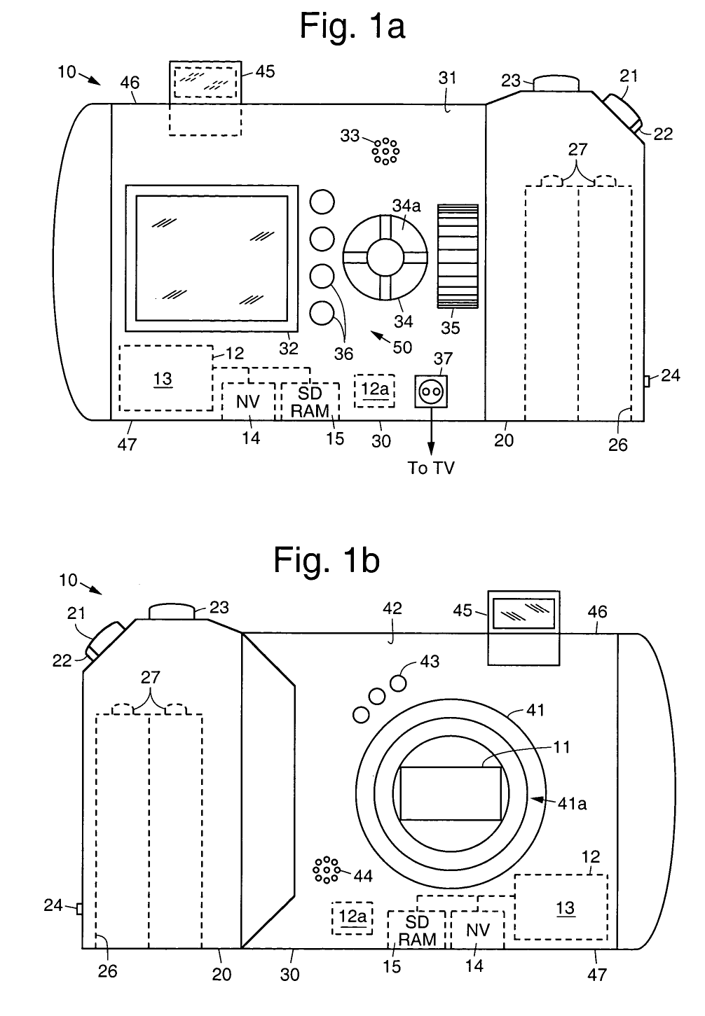

Referring to the drawing figures, FIGS. 1a and 1b are rear and front views, respectively, of an exemplary digital camera 10 implemented in accordance with the principles of the present invention. The digital camera 10 shown in FIGS. 1a and 1b is an example of a device that may incorporate the present invention but is not meant to be limiting.

As is shown in FIGS. 1a and 1b, the exemplary digital camera 10 comprises a handgrip section 20 and a body section 30. The handgrip section 20 includes a power button 21 or switch 21 having a lock latch 22, a record button 23, a strap connection 24, and a battery compartment 26 for housing batteries 27. The batteries may be inserted into the battery compartment 26 through an opening adjacent a bottom surface 47 of the digital camera 10.

As is shown in FIG. 1a, a rear surface 31 of the body section 30 comprises a liquid crystal display (LCD) 32 (image display 32 or viewfinder 32), a rear microphone 33, a joystick pad 34 including a plurality of arrow buttons 34a, a zoom control dial 35, a plurality of buttons 36 for setting functions of the camera 10 and implementing a user interface 50 (generally designated), and a video output port 37 for downloading images to a computer, or for connecting the camera 10 to a television screen (TV), for example. As is shown in FIG. 1b, a lens 41 or zoom lens 41 extends from a front surface 42 of the digital camera 10, and is attached to the body section 30 using a lens mount 41a (generally designated). A front microphone 44 is disposed on the front surface 42 of the digital camera 10. A flash unit 45 is disposed adjacent a top surface 46 of the digital camera 10.

An image sensor 11 in accordance with the present invention is coupled to processing circuitry 12 (illustrated using dashed lines) that are housed within the body section 30, for example. An exemplary embodiment of the processing circuitry 12 comprises a microcontroller (μC) 12 or central processing unit (CPU) 12. The (μC 12 or CPU 12 is typically coupled to a nonvolatile (NV) storage device 14, such as flash memory 14, for example, and a high speed (volatile) storage device 15, such as synchronous dynamic random access memory (SDRAM) 15, for example.

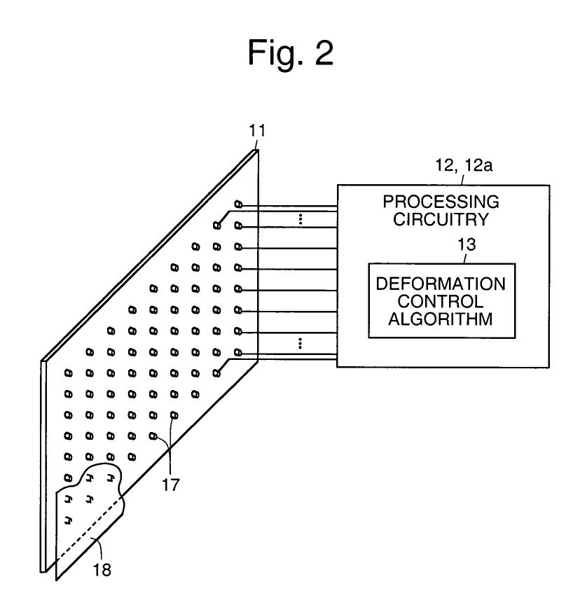

Referring to FIG. 2, which illustrates details of an exemplary flexible image sensor 11, in accordance with the principles of the present invention, a plurality of attachments 17 are coupled to a rear surface of the image sensor 11 and to a solid, substantially immovable surface 18 of the camera 10. The attachments 17 may comprise piezoelectric devices 17 or actuators 17, for example, that may be digitally controlled by the processing circuitry 12. However, it is to be understood that the attachments 17 may be digitally controlled by a separate processing circuit 12a (microcontroller 12a or central processing unit (CPU) 12a) designated for this task. The attachments 17, or piezoelectric devices 17, are coupled to the appropriate processing circuitry 12, 12a in a manner that allows digital control signals to be applied thereto that lengthen or shorten respective attachments 17 to achieve small variations in the flatness of the sensor 11.

The processing circuitry 12, 12a (microcontroller (μC) 12, 12a or CPU 12, 12a) in the digital camera 10, embodies firmware 13 comprising one or more algorithms 13 in accordance with the principles of the present invention. The firmware 13 or algorithm 13 is operative to control movement or deformation of the attachments 17 or piezoelectric devices 17, to vary the flatness of the image sensor 11.

This allows for correction of field flatness and certain lens aberrations. Alternatively, the image sensor 11 may be adjusted in gross terms, so that the image sensor 11 need not be approximately flat, and may be tilted or deformed into concave or convex shapes to correct for optical abnormalities. Thus, the sensor 11 need not be approximately flat, and may be tilted, or deformed into concave or convex shapes, for example.

As is shown in FIG. 2, the rear surface of the image sensor 11 has the plurality of (piezoelectric) attachments 17 coupled thereto. The attachments 17 are electrically connected to the processing circuitry 12, 12a so that the firmware 13 or algorithm 13 can be used to control the relative length of each of the attachments 17. This in turn, moves the sensor 11 in the vicinity of where the attachments 17 are made either towards the front or rear of the sensor 11, which deforms the image sensor 11. The attachments 17 thus provide for strain deformation of the image sensor 11.

A relatively thin image sensor 11, such as a charge coupled device (CCD), for example, is used in an image capture device, such as a digital camera. The image sensor 11 is thin enough so that a small array of attachments 17 on its back side can easily flex the sensor 11 to provide for small variations in flatness. These controlled variations correct for aberrations such as propagation delay, and angle of refraction that result from the way the light is captured through the lens 41.

This technique not only allows for correction of aberrations caused by the lens 41 but also can correct for inconsistencies in the manufacturing process of the image sensor 11, camera body (body section 30), or lens mount 41a.

The lens mount is where the lens attaches to the body of the camera 10 and is typically a close tolerance area—meaning that production dimensions should be precise and distances from this mount to the film/sensor should be maintained very accurately. Allowing some movement of the sensor allows these tolerances to be loosened (or any existing irregularity to be fine-tuned) as long as there is a method to find the correct distance.

For example, if the image capture device had the image sensor 11 attached slightly unevenly, this would normally result in the product being rejected. With a sensor 11 that can be flexed, firmware 13 in the processing circuitry 12, 12a may be used to set a default sensor position to correct for this manufacturing defect, and the net result would only be the device's inability to compensate as much for lens aberrations. Lens distance tolerances may be relieved, or the resulting performance improved, by allowing the entire sensor to move slightly forward or back by appropriately controlling the attachments 17.

Also, changing the resulting image using lens settings produces barrel and pincushion spatial distortions. A typical zoom lens 41 will produce barrel distortion at wide angle position and pincushion distortion in telephoto position. By producing compensating distortion in the image sensor 11 by appropriately controlling the attachments 17, the end result is that some of this distortion is removed.

Lastly, the present invention can be used in high end instruments such as astrophotography sensors, for example. Typically, in high end instruments that include a mirror in the optical path, the mirror must be modified to compensate for distortion. By using the present invention, the mirror can be unchanged or the mirror and sensor can work in tandem to allow faster compensations (due to the sensor size compared to the mirror size), or more compensation may be achieved compared with what is achievable with just one adaptive device.

The present invention allows for imaging devices, such as digital cameras 10, to correct physically for aberrations instead of relying on post processing to correct. The present invention also allows a manufacturer to have a wider tolerance for defects in production of both the imaging device and the lenses.

Thus, improved digital cameras having a deformable image sensor has been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A digital camera comprising:
a flexible image sensor; and
a plurality of deformable attachments coupled between a rear surface of the image sensor and a substantially immovable surface.

2. The digital camera recited in claim 1 further comprising:
processing circuitry coupled to the plurality of attachments.

3. The digital camera recited in claim 2 further comprising:
firmware that runs on the processing circuitry, that implements a deformation algorithm that selectively deforms the attachments to vary the flatness of the sensor.

4. The digital camera recited in claim 1 wherein the attachments comprise piezoelectric devices.

5. The digital camera 10 recited in claim 2 wherein the attachments are digitally controlled by the processing circuitry.

6. The digital camera recited in claim 1 wherein the image sensor comprises a charge coupled device.

7. Imaging apparatus for use in a digital camera, comprising:
flexible image sensor means; and
a plurality of deformable attachments coupled between a rear surface of the image sensor means and a substantially immovable surface.

8. The apparatus recited in claim 7 further comprising:
processing means coupled to the plurality of attachments.

9. The apparatus recited in claim 8 further comprising:
firmware that runs on the processing means, that implements a deformation algorithm that selectively deforms the deformable attachments to vary the flatness of the sensor means.

10. The apparatus recited in claim 7 wherein the deformable attachments comprise piezoelectric devices.

11. The apparatus recited in claim 7 wherein the deformable attachments are digitally controlled by the processing circuitry.

12. The apparatus recited in claim 7 wherein the image sensor means comprises a charge coupled device.

13. In an imaging apparatus, a method comprising:
providing the imaging apparatus with a flexible image sensor;
correcting for sensor deformities by selectively flexing the flexible image sensor.

14. The method recited in claim 13 wherein the step of selectively flexing the flexible image sensor comprises:
flexing a plurality of deformable attachments coupled to the flexible image sensor.

15. The method recited in claim 13 wherein the step of selectively flexing the flexible image sensor comprises:
flexing a plurality of deformable piezoelectric devices coupled to the flexible image sensor.
